(19) United States
(12) Patent Application Publication
(10) Pub. No.: US 2024/0025442 A1
(43) Pub. Date: Jan. 25, 2024

(54) TRAJECTORY PLANNING IN AUTONOMOUS DRIVING VEHICLES FOR UNFORESEEN SCENARIOS

(71) Applicant: Baidu USA LLC, Sunnyvale, CA (US)

(72) Inventors: Shu JIANG, Sunnyvale, CA (US); Szu Hao WU, Sunnyvale, CA (US); Hao LIU, Sunnyvale, CA (US); Yu CAO, Sunnyvale, CA (US); Weiman LIN, Sunnyvale, CA (US); Helen K. PAN, Sunnyvale, CA (US)

(21) Appl. No.: 17/814,356

(22) Filed: Jul. 22, 2022

(51) Int. Cl. B60W 60/00; B60W 40/04; G06N 20/00

(52) U.S. Cl. CPC B60W 60/0011; B60W 60/0015; B60W 40/04; G06N 20/00; B60W 2554/4044; B60W 2554/408

(57) ABSTRACT

According to some embodiments, systems, methods and media for operating an autonomous driving vehicles (ADV) in an unforeseen scenario are disclosed. In one embodiment, an exemplary method includes determining that the ADV has entered an unforeseen scenario; and identifying one or more surrounding vehicles that are navigating the unforeseen scenario. The method further includes generating a trajectory by mimicking driving behaviors of one or more of the one or more surrounding vehicles; and operating the ADV to follow the trajectory to navigate the unforeseen scenario.

### TECHNICAL FIELD

Embodiments of the present disclosure relate generally to operating autonomous vehicles. More particularly, embodiments of the disclosure relate to trajectory planning for unforeseen scenarios.

### BACKGROUND

An autonomous driving vehicle (ADV), when driving in an automatic mode, can relieve occupants, especially the driver, from some driving-related responsibilities. When operating in an autonomous mode, the vehicle can navigate to various locations using onboard sensors, allowing the vehicle to travel with minimal human interaction, or in some cases without any passengers.

The ADV may be configured with rules or trained using historical training data so that it can navigate various driving scenarios. Examples of the driving scenarios can include a left turn, a right turn, a junction, and a straight lane. However, the road conditions may change unexpectedly, resulting in a driving scenario that the ADV is not trained for or is not configured to handle.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3A-3B are block diagrams illustrating an example of an autonomous driving system used with an autonomous driving vehicle according to one embodiment.

FIG. 4 is a block diagram illustrating an example of a decision and planning system according to one embodiment.

FIG. 5 illustrates a planning module with a mimicking planner in accordance with an embodiment.

FIG. 6 further illustrates the planning module according to one embodiment.

FIG. 7 further illustrates the planning module according to one embodiment.

FIG. 8 is a flow chart illustrating a process of operating an ADV according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to various embodiments, systems, methods and media for operating an autonomous driving vehicle (ADV) in an unforeseen scenario are disclosed. In one embodiment, an exemplary method includes determining that the ADV has entered an unforeseen scenario; and identifying one or more surrounding vehicles that are navigating the unforeseen scenario. The method further includes generating a trajectory by mimicking driving behaviors of one or more of the one or more surrounding vehicles; and operating the ADV to follow the trajectory to navigate the unforeseen scenario.

In an embodiment, the ADV includes a learning-based mimicking planner or a rule-based mimicking planner. With a learning-based mimicking planner, the ADV can determine a scenario that is out of distribution of training data used to train the learning-based planner as an unforeseen scenario. With a rule-based planner, the ADV can determine a scenario that is not defined by rules in the rule-based planner as an unforeseen scenario.

In an embodiment, the one or more surrounding vehicles that are navigating the unforeseen scenarios are in front of the ADV, and are travelling in the same direction as the ADV. When the one or more surrounding vehicles include one vehicle, the learning-based planner is fine-tuned using one-short fine-tuning techniques based on real-time environment data and current states of the ADV during a first time period, and then generates the trajectory of the ADV based on real-time environment data and current states of the ADV during a second time period. When the one or more surrounding vehicles include multiple vehicles, the learning-based planner is fine-tuned using few-short fine-tuning techniques based on real-time environment data and current states of the ADV during a first time period, and then generates the trajectory of the ADV based on real-time environment data and current states of the ADV during a second time period.

In an embodiment, the learning-based planner is a long-short term memory (LSTM) decoder, and the determining that the ADV has entered an unforeseen scenario is based on environment information encoded in a long-short term memory (LSTM) encoder.

In an embodiment, with one vehicle surrounding the ADV and a rule-based planner, the ADV can generate the trajectory for navigating the unforeseen scenario based on a trajectory of the surrounding vehicle and current states of the ADV during the first time period. With multiple surrounding vehicles, however, the ADV can use the rule-based planner to generate the trajectory for navigating the unforeseen scenario based on a trajectory of a selected surrounding vehicle and current vehicle states of the ADV during the first time period.

The embodiments described above are not exhaustive of all aspects of the present invention. It is contemplated that the invention includes all embodiments that can be practiced from all suitable combinations of the various embodiments summarized above, and also those disclosed below.

### Autonomous Driving Vehicle

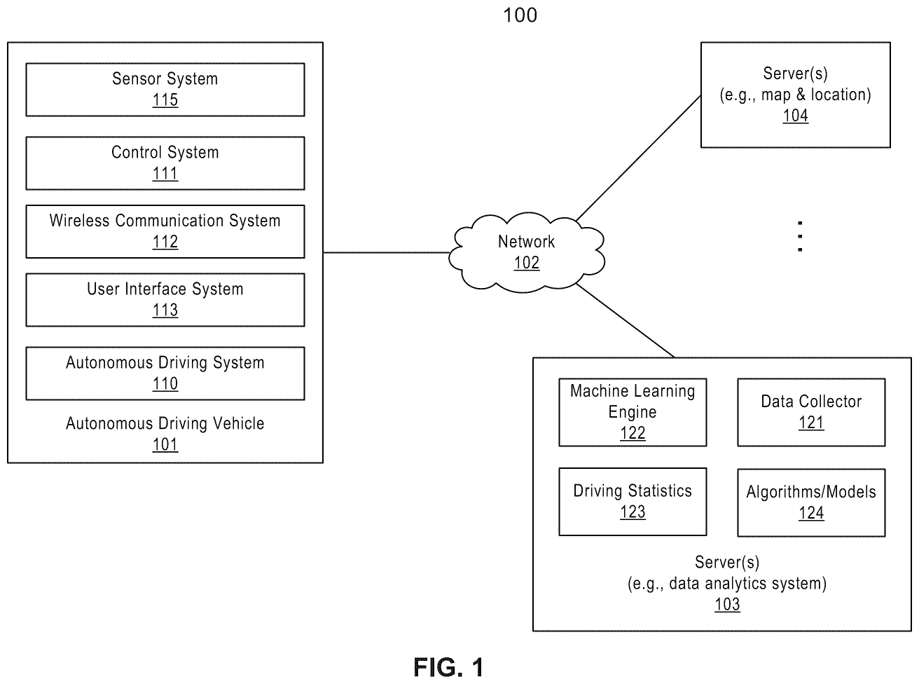

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

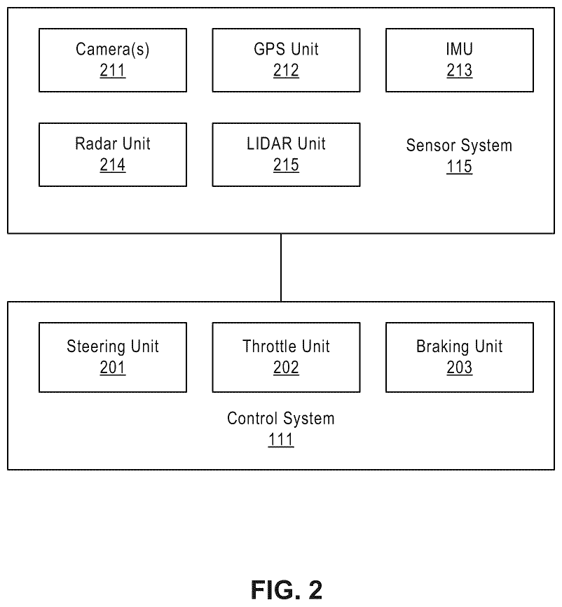

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

Server 103 may be a data analytics system to perform data analytics services for a variety of clients. In one embodiment, data analytics system 103 includes data collector 121 and machine learning engine 122. Data collector 121 collects driving statistics 123 from a variety of vehicles, either ADVs or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc.

Based on driving statistics 123, machine learning engine 122 generates or trains a set of rules, algorithms, and/or predictive models 124 for a variety of purposes. Algorithms 124 can then be uploaded on ADVs to be utilized during autonomous driving in real-time.

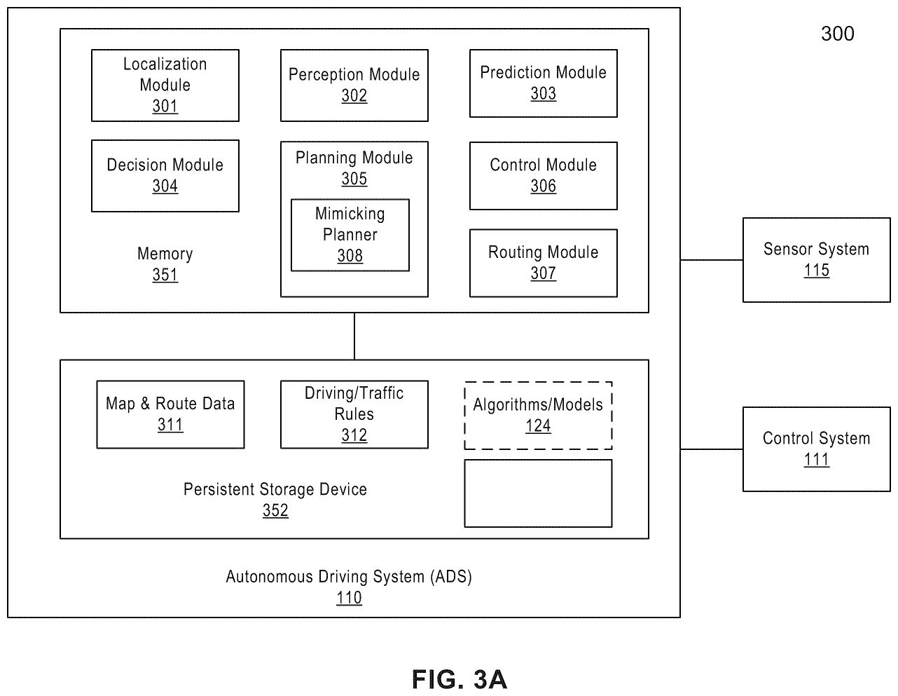

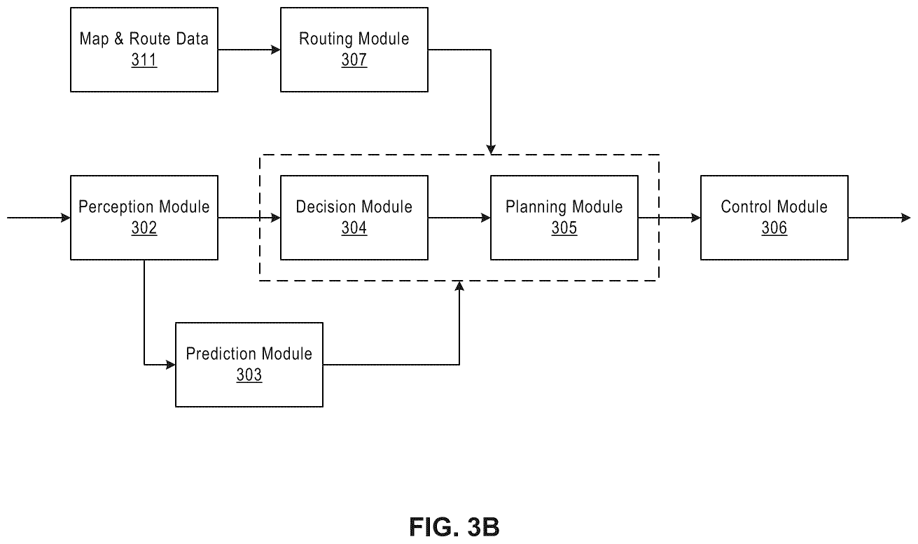

FIGS. 3A and 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, and routing module 307.

Some or all of modules 301-307 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-307 may be integrated together as an integrated module.

Localization module 301 determines a current location of ADV 101 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 101, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 101 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph. The planning module 305 can include a mimicking planner 308, which can be invoked when vehicle 101 enters an unforeseen scenario.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

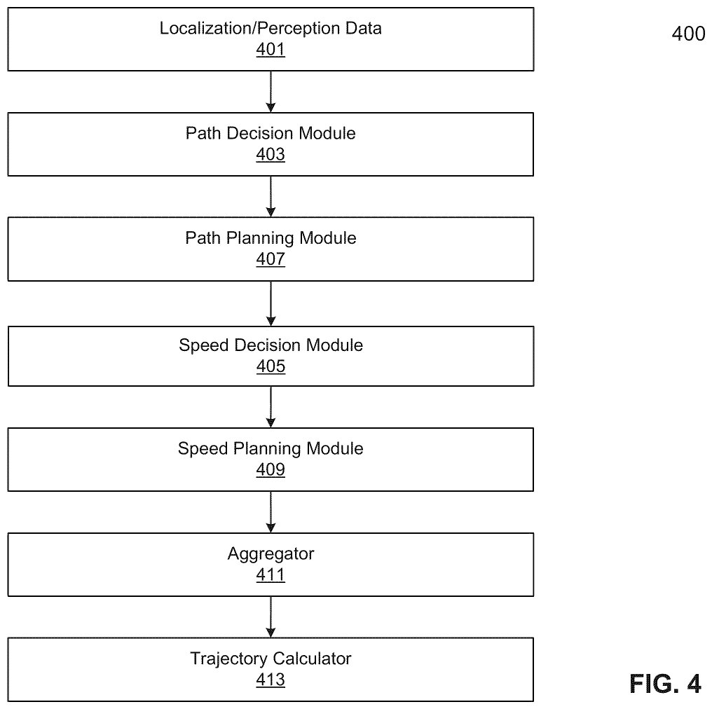

FIG. 4 is a block diagram illustrating an example of a decision and planning system according to one embodiment. System 400 may be implemented as part of system 300 of FIGS. 3A-3B to perform path planning and speed planning operations. Referring to FIG. 4, Decision and planning system 400 (also referred to as a planning and control or PnC system or module) includes, amongst others, routing module 307, localization/perception data 401, path decision module 403, speed decision module 405, path planning module 407, speed planning module 409, aggregator 411, and trajectory calculator 413.

Path decision module 403 and speed decision module 405 may be implemented as part of decision module 304. In one embodiment, path decision module 403 may include a path state machine, one or more path traffic rules, and a station-lateral maps generator. Path decision module 403 can generate a rough path profile as an initial constraint for the path/speed planning modules 407 and 409 using dynamic programming.

In one embodiment, the path state machine includes at least three states: a cruising state, a changing lane state, and/or an idle state. The path state machine provides previous planning results and important information such as whether the ADV is cruising or changing lanes. The path traffic rules, which may be part of driving/traffic rules 312 of FIG. 3A, include traffic rules that can affect the outcome of a path decisions module. For example, the path traffic rules can include traffic information such as construction traffic signs nearby the ADV can avoid lanes with such construction signs. From the states, traffic rules, reference line provided by routing module 307, and obstacles perceived by perception module 302 of the ADV, path decision module 403 can decide how the perceived obstacles are handled (i.e., ignore, overtake, yield, stop, pass), as part of a rough path profile.

For example, in one embedment, the rough path profile is generated by a cost function consisting of costs based on: a curvature of path and a distance from the reference line and/or reference points to obstacles. Points on the reference line are selected and are moved to the left or right of the reference lines as candidate movements representing path candidates. Each of the candidate movements has an associated cost. The associated costs for candidate movements of one or more points on the reference line can be solved using dynamic programming for an optimal cost sequentially, one point at a time.

In one embodiment, a state-lateral (SL) maps generator (not shown) generates an SL map as part of the rough path profile. An SL map is a two-dimensional geometric map (similar to an x-y coordinate plane) that includes obstacles information perceived by the ADV. From the SL map, path decision module 403 can lay out an ADV path that follows the obstacle decisions. Dynamic programming (also referred to as a dynamic optimization) is a mathematical optimization method that breaks down a problem to be solved into a sequence of value functions, solving each of these value functions just once and storing their solutions. The next time the same value function occurs, the previous computed solution is simply looked up saving computation time instead of recomputing its solution.

Speed decision module 405 or the speed decision module includes a speed state machine, speed traffic rules, and a station-time graphs generator (not shown). Speed decision process 405 or the speed decision module can generate a rough speed profile as an initial constraint for the path/speed planning modules 407 and 409 using dynamic programming. In one embodiment, the speed state machine includes at least two states: a speed-up state and/or a slow-down state. The speed traffic rules, which may be part of driving/traffic rules 312 of FIG. 3A, include traffic rules that can affect the outcome of a speed decisions module. For example, the speed traffic rules can include traffic information such as red/green traffic lights, another vehicle in a crossing route, etc. From a state of the speed state machine, speed traffic rules, rough path profile/SL map generated by decision module 403, and perceived obstacles, speed decision module 405 can generate a rough speed profile to control when to speed up and/or slow down the ADV. The SL graphs generator can generate a station-time (ST) graph as part of the rough speed profile.

In one embodiment, path planning module 407 includes one or more SL maps, a geometry smoother, and a path costs module (not shown). The SL maps can include the station-lateral maps generated by the SL maps generator of path decision module 403. Path planning module 407 can use a rough path profile (e.g., a station-lateral map) as the initial constraint to recalculate an optimal reference line using quadratic programming. Quadratic programming (QP) involves minimizing or maximizing an objective function (e.g., a quadratic function with several variables) subject to bounds, linear equality, and inequality constraints.

One difference between dynamic programming and quadratic programming is that quadratic programming optimizes all candidate movements for all points on the reference line at once. The geometry smoother can apply a smoothing algorithm (such as B-spline or regression) to the output station-lateral map. The path costs module can recalculate a reference line with a path cost function, to optimize a total cost for candidate movements for reference points, for example, using QP optimization performed by a QP module (not shown). For example, in one embodiment, a total path cost function can be defined as follows:

path cost=Σₚₒᵢₙₜₛ(heading)²+Σₚₒᵢₙₜₛ(curvature)²+Σₚₒᵢₙₜₛ(distance)²,

where the path costs are summed over all points on the reference line, heading denotes a difference in radial angles (e.g., directions) between the point with respect to the reference line, curvature denotes a difference between curvature of a curve formed by these points with respect to the reference line for that point, and distance denotes a lateral (perpendicular to the direction of the reference line) distance from the point to the reference line. In some embodiments, distance represents the distance from the point to a destination location or an intermediate point of the reference line. In another embodiment, the curvature cost is a change between curvature values of the curve formed at adjacent points. Note the points on the reference line can be selected as points with equal distances from adjacent points. Based on the path cost, the path costs module can recalculate a reference line by minimizing the path cost using quadratic programming optimization, for example, by the QP module.

Speed planning module 409 includes station-time graphs, a sequence smoother, and a speed costs module. The station-time graphs can include a ST graph generated by the ST graphs generator of speed decision module 405. Speed planning module 409 can use a rough speed profile (e.g., a station-time graph) and results from path planning module 407 as initial constraints to calculate an optimal station-time curve. The sequence smoother can apply a smoothing algorithm (such as B-spline or regression) to the time sequence of points. The speed costs module can recalculate the ST graph with a speed cost function to optimize a total cost for movement candidates (e.g., speed up/slow down) at different points in time. For example, in one embodiment, a total speed cost function can be:

speed cost=Σₚₒᵢₙₜₛ(speed′)²+Σₚₒᵢₙₜₛ(speed″)²+(distance)²,

where the speed costs are summed over all time progression points, speed′ denotes an acceleration value or a cost to change speed between two adjacent points, speed″ denotes a jerk value, or a derivative of the acceleration value or a cost to change the acceleration between two adjacent points, and distance denotes a distance from the ST point to the destination location. Here, the speed costs module calculates a station-time graph by minimizing the speed cost using quadratic programming optimization, for example, by the QP module.

Aggregator 411 performs the function of aggregating the path and speed planning results. For example, in one embodiment, aggregator 411 can combine the two-dimensional ST graph and SL map into a three-dimensional SLT graph. In another embodiment, aggregator 411 can interpolate (or fill in additional points) based on two consecutive points on an SL reference line or ST curve. In another embodiment, aggregator 411 can translate reference points from (S, L) coordinates to (x, y) coordinates. Trajectory generator 413 can calculate the final trajectory to control ADV 101. For example, based on the SLT graph provided by aggregator 411, trajectory generator 413 calculates a list of (x, y, T) points indicating at what time should the ADC pass a particular (x, y) coordinate.

Thus, path decision module 403 and speed decision module 405 are configured to generate a rough path profile and a rough speed profile taking into consideration obstacles and/or traffic conditions. Given all the path and speed decisions regarding the obstacles, path planning module 407 and speed planning module 409 are to optimize the rough path profile and the rough speed profile in view of the obstacles using QP programming to generate an optimal trajectory with minimum path cost and/or speed cost.

### Trajectory Planning for Unforeseen Scenarios

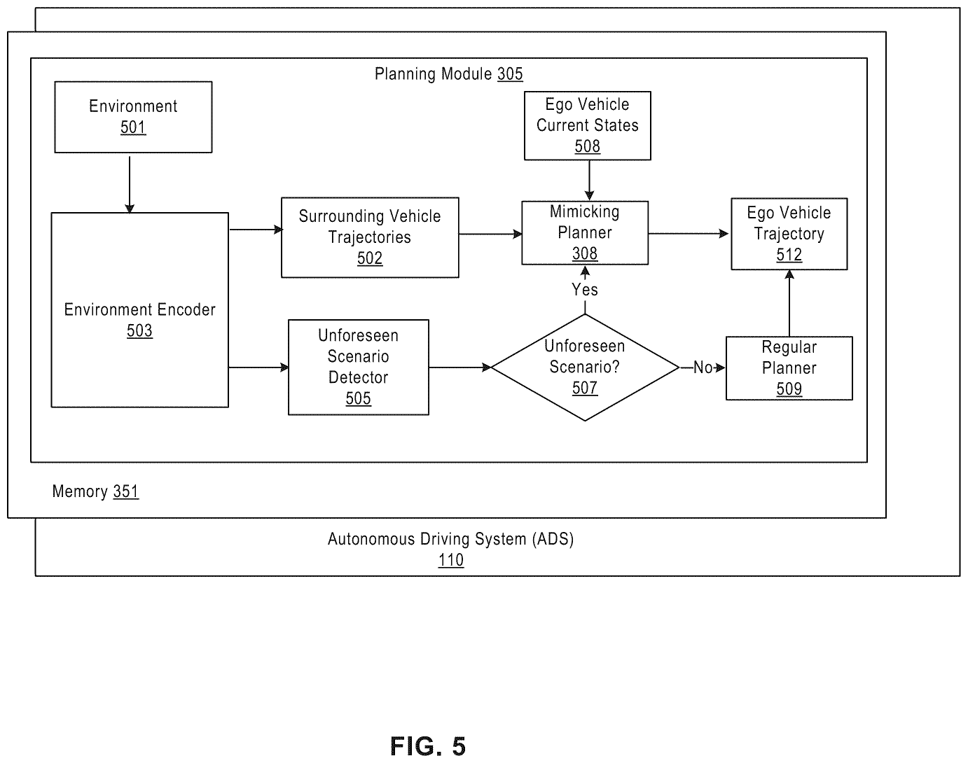

FIG. 5 illustrates a planning module with a mimicking planner in accordance with an embodiment.

As shown, the planning module 305 includes a mimicking planner 308 and a regular planner 509, each of which can be a rule-based planner, a learning-based planner, or a combination thereof

A rule-based planner can formulate motion planning as constrained optimization problems, is reliable and interpretable, but its performance heavily depends on how well the optimization problems are formulated with parameters. These parameters are designed for various purposes, such as modeling different scenarios, balancing the weights of each individual objective, and thus require manual fine-tuning for optimal performance. A learning-based planner, on the other hand, learns from the massive amount of human demonstrations to create human-like driving plans, thus avoiding the tedious design process of rules and constraints.

The combination of the rule-based planner and the learning-based planner can take the form of a learning-based planner being integrated into an existing rule-based planner. With such a combination, the planning module 305 can take advantage of the benefits of both rule-based planning and learning-based planning.

In an embodiment, the planning module 305 can select the mimicking planner 308 or the regular planner 509 to generate trajectories for the ADV 101 based on whether the ADV 101 has entered an unforeseen scenario. If the ADV 101 is determined to have entered an unforeseen scenario, the ADV 101 can invoke the mimicking planner 308; otherwise, it can invoke the regular planner 509.

The mimicking planner 308 can mimic driving behaviors of one or more surrounding vehicles that are navigating the detected unforeseen scenario. In one implementation, the mimicking planner 308 can mimic the trajectories of the surrounding vehicle. For example, the mimicking planner 308 can generate a trajectory 512 for the ADV 101 to navigate the unforeseen scenario based on current states of the ADV 101 and trajectories 502 of surrounding vehicles navigating the unforeseen scenarios.

The current states of the ADV 101 include one or more of a position, a heading, a speed, an acceleration, a deceleration, or a trajectory of the ADV 101. The trajectory 512 of the ADV 101 can be a sequence of positions and headings at different times. Similarly, each of the surrounding vehicle trajectories 502 can be a sequence of positions and headings of the corresponding surrounding vehicle.

As shown, an unforeseen scenario detector 505 can perform an operation 507 on an environment 501 encoded by an environment encoder 503 to determine whether the ADV 101 has entered an unforeseen scenario. The environment 501 can be the surrounding environment of the ADV 101, and can includes map information, traffic information, and any other information in the environment 501. In one embodiment, the surrounding environment 501 can also include the surrounding vehicle trajectories 502 as perceived by sensors on the ADV 101.

In an embodiment, the environment encoder 503 can be VectorNet, which is a hierarchical graph neural network that first exploits the spatial locality of individual road components represented by vectors, and then models the high-order interactions among all components.

In an embodiment, the unforeseen scenario detector 505 can use different approaches to detect an unforeseen scenario, depending on the type of the planning module 305. When the planning module 305 is a learning-based planner, the unforeseen scenario detector 505 can check whether the environment 501 as encoded by the environment encoder 503 is out of distribution of the training data used to train the learning-based planner. When the planning module 305 is a rule-based planner, the unforeseen scenario detector 505 can check whether the environment 501 as encoded by the environment encoder 503 is out of the designed ruleset, meaning that ADV 101 does not have rules for this particular scenario. An example of an unforeseen scenario is a roundabout on a road that is not reflected in a high definition (HD) map, or a construction worker holding a stop sign or a new instruction sign at a construction site.

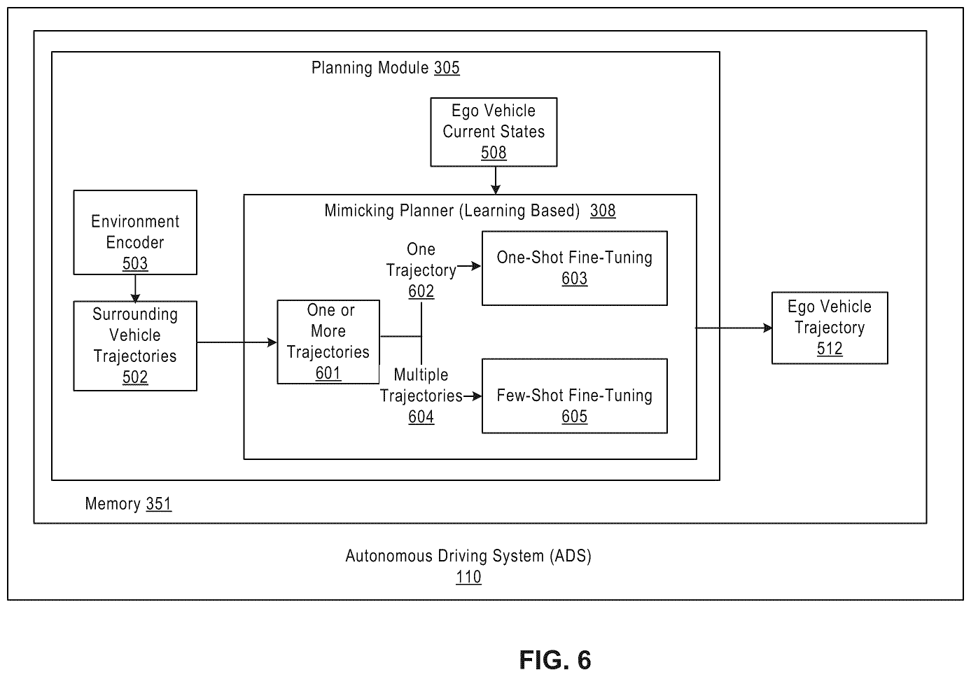

FIG. 6 further illustrates the planning module 305 according to one embodiment. More specifically, in this embodiment, the mimicking planner 308 is a learning-based planner.

As shown in FIG. 6, the learning-based mimicking planner 308 can be pre-trained using generic driving datasets to provide high-level driving instructions, such as, when to slow down, etc. However, the pre-trained mimicking planner 308 does not directly provide driving-scenario-specific driving instructions. Instead, when the ADV 101 has detected an unforeseen driving scenario, the pre-trained mimicking planner 308 can be fine-tuned using the current states 508 of the ADV 101 and the surrounding vehicle trajectories 502, and the fine-tuned mimicking planner 308 can then be used to generate the trajectory 512 for the ADV 101 to navigate the unforeseen scenario.

In an embodiment, the learning-based mimicking planner 308 can be part of a long-short term memory (LSTM) encoder-decoder architecture. The LSTM encoder can be the environment encoder 503, and the LSTM decoder can be the learning-based mimicking planner 308. The LSTM encoder (i.e., the environment encoder 503) processes input sequences through multiple cell gate vectors, and summarizes the whole input sequences into a final state vector. The LSTM encoder then passes the final state vector to the LSTM decoder (i.e. the learning-based mimicking planner 308), which can use the current states of the ADV 101 and the final state vector from the LSTM encoder to recursively generate an output sequence, e.g., the trajectory 512 of the ADV 101.

In one embodiment, the pre-trained mimicking planner 308 can be fine-tuned in real time using part of real-time data (i.e., the current states of the ADV 101 and the surrounding vehicle trajectories). Fine-tuning the pre-trained mimicking planner 308 means re-training it using the part of the real-time data to attune the mimicking planner 308 that has been pre-trained using generic datasets to focus on the unforeseen scenario.

In one embodiment, the part of the real-time data can be the current states of the ADV 101 and trajectories of the surrounding vehicles within a particular time interval (e.g., the first 200 ms) after the ADV 101 detects the surrounding vehicles. Then, the fine-tuned mimicking planner 308 can be used to generate the trajectory 512 based on the current states of the ADV 101 and trajectories of the surrounding vehicles during another time interval.

The mimicking planner 308 can use different fine-tuning techniques, depending on the number of trajectories 601 (i.e., the number of surrounding vehicles navigating the unforeseen scenarios). When there is only one trajectory 602 (i.e. one vehicle navigating the unforeseen scenario in the vicinity of the ADV 101), the mimicking planner 308 can use one-shot fine-tuning techniques 603 to generate the trajectory 512 for the ADV 101. When there are multiple trajectories 604 (i.e., multiple vehicles in the vicinity of the ADV 101), the mimicking planner 308 can use few-shot fine-tuning 605 to generate the trajectory 512 for the ADV 101. If there is no surrounding vehicle navigating the unforeseen scenario, the ADV 101 can slow down and stop, or generate an alert requesting the intervention of a human driver.

As an illustrative example of the one-shot fine-tuning techniques used when there is only one surrounding vehicle (i.e. one trajectory), the mimicking planner 308 can be re-trained/fine-tuned using the trajectory and current states of the ADV 101 during a particular time interval, and then can be used to generate the trajectory 512 for the ADV to navigate the unforeseen scenario based on the trajectory and the current states of the ADV 101 in another time interval.

As an illustrative example of the few-shot fine-tuning technique used when there are multiple surrounding vehicles (i.e., multiple trajectories), the pre-trained mimicking planner 308 can be re-trained/fine-tuned using the multiple trajectories and current states of the ADV 101 within a particular time interval, and then can be used to generate the trajectory 512 for the ADV 101 using the multiple trajectories and the currents states of the ADV 101 during another time interval.

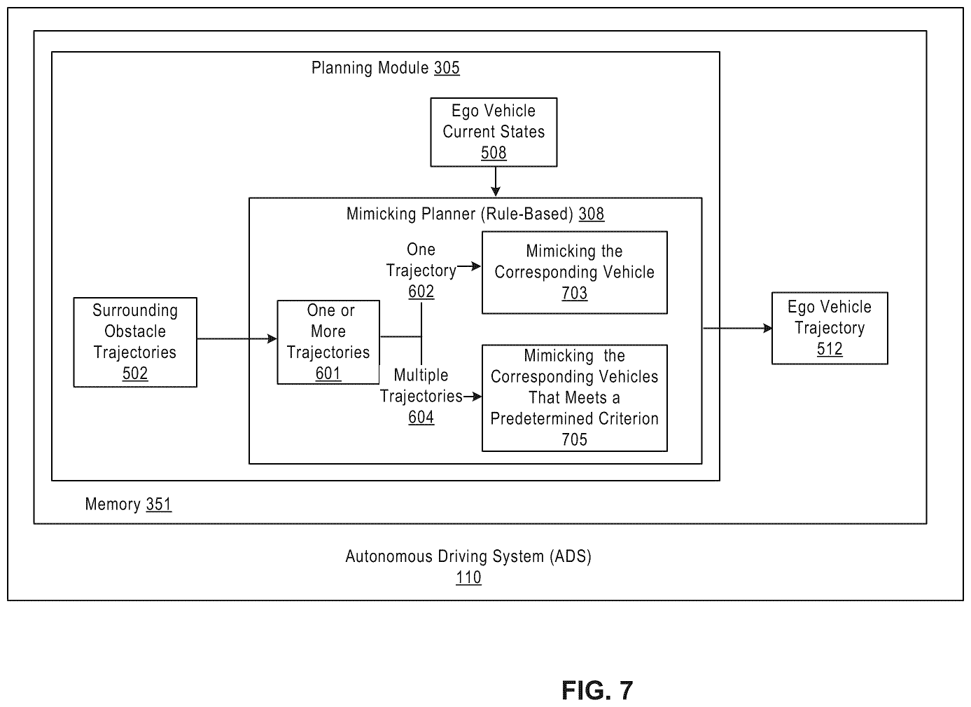

FIG. 7 further illustrates the planning module 305 according to one embodiment. More specifically, in this embodiment, the mimicking planner 308 is a rule-based planner.

As shown, the rule-based mimicking planner 308 can use different approaches to mimic the driving behaviors of the surrounding vehicles based on the number of surrounding vehicles (i.e. the number of trajectories 601) navigating the unforeseen scenario. When there is one trajectory 602 (i.e., one surrounding vehicle), the mimicking planner 308 can perform a mimicking operation 703 to mimic the trajectory 602; if there are multiple trajectories 604 (i.e. multiple surrounding vehicles), the mimicking planner 308 can perform a mimicking operation 705 to select a surrounding vehicle that meets a predetermined criterion to mimic. If there is no surrounding vehicle navigating the unforeseen scenario, the ADV 101 can slow down and stop, or generate an alert requesting the intervention of a human driver if there is one in the ADV 101.

In an embodiment, when selecting a surrounding vehicle from the multiple surrounding vehicles 604 to mimic, the rule-based mimicking planner 308 can select the vehicle that is in immediate front of the ADV 101, or can select the vehicle whose trajectory enables the ADV 101 to arrive at its destination in the shortest amount of time.

As an illustrative example, the ADV 101 has entered a roundabout which is determined by the ADV 101 to be an unforeseen scenario, there are three surrounding vehicles in front of the ADV 101, and the three surrounding vehicles all entered the roundabout from the same entrance to the roundabout, with the first vehicle entering the roundabout first, the second vehicle later, and the third vehicle last. Then, the first vehicle is to exit the roundabout at a right exit, the second vehicle is to exit the roundabout at a left exit, and the third vehicle is to exit the roundabout at a middle exit. The ADV 101 can mimic the first vehicle since it is the vehicle that is immediately in front of the ADV 101.

Alternatively, the ADV 101 can calculate distances of different potential routes between the roundabout and the destination of the ADV 101 based on map information. The different potential routes result from the ADV 101 exiting at the different exits of the roundabout. The ADV 101 can identify a route with the shortest distance, determine which vehicle is to exit at the exit associated with that route, and mimic the trajectory of that vehicle when generating the trajectory 512 for the ADV 101.

In an embodiment, the ADV 101 does not have to wait for the three surrounding vehicles to complete their trajectory to navigate the unforeseen scenario before selecting a vehicle to mimic. As soon as the ADV 101 has enough information to determine the potential trajectories of the surrounding vehicles, e.g., with the first 2 seconds of each of the trajectories starting from the point of time when the vehicle is spotted by the ADV 101, the ADV 101 can start to make a selection. The ADV 101 can then generate the 512 based on the presumed trajectory of the selected vehicle and the current states of the ADV 101.

For example, if the ADV 101 has determined to mimic a vehicle that will change to a destination lane based on the trajectory of the vehicle within the first two seconds after the ADV 101 detects the vehicle, the ADV 101 can start to generate the trajectory 512 that can lead the ADV 101 to the destination lane.

In an embodiment, when selecting a surrounding vehicle to mimic, the ADV 101 may ignore surrounding vehicles that are trailing the ADV 101 in the same lane.

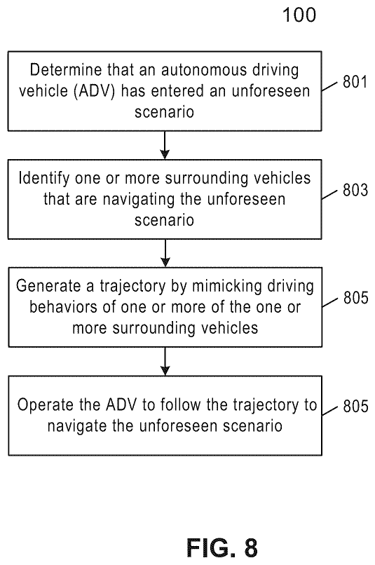

FIG. 8 is a flow chart illustrating a process 800 of operating an ADV according to one embodiment. The process may be performed by processing logic which may include software, hardware, or a combination thereof. For example, the process may be performed by the planning module 305 described in FIG. 5 or one or more other modules in the ADV 101.

Referring to FIG. 8, in operation 801, the processing logic determines that the ADV has entered an unforeseen scenario. The determining that the ADV has entered such a scenario can be performed by an unforeseen scenario detector based on environment information encoded in an LSTM encoder.

In operation 803, the processing logic identifies one or more surrounding vehicles that are navigating the unforeseen scenario. The identifying of the surrounding vehicle can be based on sensor data collected by the ADV and/or map information, and only those surrounding vehicles traveling in the same direction as the ADV may be considered.

In operation 805, the processing logic generates a trajectory for the ADV by mimicking driving behaviors of one or more of the one or more surrounding vehicles. The mimicking of the driving behaviors of the one or more of the one or more surrounding vehicles includes fine-tuning a learning-based mimicking planner using a portion of real-time data and then using the fine-tuned learning-based planner to generate the trajectory, or copying a trajectory of a surrounding vehicle (e.g., when the ADV includes a rule-based mimicking planner).

In operation 807, the processing logic operates the ADV to follow the trajectory to navigate the unforeseen scenario.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method of operating an autonomous driving vehicle (ADV), comprising:
determining that the ADV has entered an unforeseen scenario;
identifying one or more surrounding vehicles that are navigating the unforeseen scenario;
generating a trajectory by mimicking driving behaviors of one or more of the one or more surrounding vehicles; and
operating the ADV to follow the trajectory to navigate the unforeseen scenario.

2. The computer-implemented method of claim 1, wherein the ADV includes a learning-based planner, wherein the unforeseen scenario is a scenario that is out of distribution of training data used to train the learning-based planner.

3. The computer-implemented method of claim 2, wherein the one or more surrounding vehicles that are navigating the unforeseen scenarios are in front of the ADV and are travelling in a same direction as the ADV.

4. The computer-implemented method of claim 2, wherein the one or more surrounding vehicles include one vehicle, wherein the learning-based planner is fine-tuned using one-short fine-tuning techniques based on real-time environment data and current states of the ADV during a first time period, and generates the trajectory of the ADV based on real-time environment data and current states of the ADV during a second time period.

5. The computer-implemented method of claim 2, wherein the one or more surrounding vehicles include multiple vehicles, wherein the learning-based planner is fine-tuned using few-short fine-tuning techniques based on real-time environment data and current states of the ADV during a first time period, and generates the trajectory of the ADV based on real-time environment data and current states of the ADV during a second time period.

6. The computer-implemented method of claim 2, wherein the learning-based planner is a long-short term memory (LSTM) decoder.

7. The computer-implemented method of claim 2, wherein the determining that the ADV has entered an unforeseen scenario is based on environment information encoded in a long-short term memory (LSTM) encoder.

8. The computer-implemented method of claim 1, wherein the ADV includes a rule-based planner, wherein the unforeseen scenario is a scenario that is not defined by rules in the rule-based planner.

9. The computer-implemented method of claim 8, wherein the one or more surrounding vehicles include one vehicle, wherein the rule-based planner generates the trajectory for the ADV based on current vehicle states of the ADV and a trajectory of the one vehicle during a first time period.

10. The computer-implemented method of claim 8, wherein the one or more surrounding vehicles include multiple vehicles, wherein the rule-based planner generates a trajectory for the ADV based on current vehicle states of the ADV and a trajectory of one of the multiple vehicles that meets a predetermined criterion during a first time period.

11. The computer-implemented method of claim 10, wherein the predetermined criterion is one of being in the immediate front of the ADV.

12. A non-transitory machine-readable medium having instructions stored therein, which when executed by a processor, cause the processor to perform operations for operating an autonomous driving vehicle (ADV), the operations comprising:
determining that the ADV has entered an unforeseen scenario;
identifying one or more surrounding vehicles that are navigating the unforeseen scenario;
generating a trajectory by mimicking driving behaviors of one or more of the one or more surrounding vehicles; and
operating the ADV to follow the trajectory to navigate the unforeseen scenario.

13. The non-transitory machine-readable medium of claim 12, wherein the ADV includes a learning-based planner, wherein the unforeseen scenario is a scenario that is out of distribution of training data used to train the learning-based planner.

14. The non-transitory machine-readable medium of claim 13, wherein the one or more surrounding vehicles that are navigating the unforeseen scenarios are in front of the ADV and are travelling in a same direction as the ADV.

15. The non-transitory machine-readable medium of claim 13, wherein the one or more surrounding vehicles include one vehicle, wherein the learning-based planner is fine-tuned using one-short fine-tuning techniques based on real-time environment data and current states of the ADV during a first time period, and generates the trajectory of the ADV based on real-time environment data and current states of the ADV during a second time period.

16. The non-transitory machine-readable medium of claim 13, wherein the one or more surrounding vehicles include multiple vehicles, wherein the learning-based planner is fine-tuned using few-short fine-tuning techniques based on real-time environment data and current states of the ADV during a first time period, and generates the trajectory of the ADV based on real-time environment data and current states of the ADV during a second time period.

17. The non-transitory machine-readable medium of claim 13, wherein the learning-based planner is a long-short term memory (LSTM) decoder.

18. The non-transitory machine-readable medium of claim 13, wherein the determining that the ADV has entered an unforeseen scenario is based on environment information encoded in a long-short term memory (LSTM) encoder.

19. The non-transitory machine-readable medium of claim 12, wherein the ADV includes a rule-based planner, wherein the unforeseen scenario is a scenario that is not defined by rules in the rule-based planner.

20. A data processing system, comprising:
a processor; and
a memory coupled to the processor to store instructions, which when executed by the processor, cause the processor to perform operations of operating an autonomous driving vehicle (ADV), the operations comprising:
determining that the ADV has entered an unforeseen scenario,
identifying one or more surrounding vehicles that are navigating the unforeseen scenario,
generating a trajectory by mimicking driving behaviors of one or more of the one or more surrounding vehicles, and
operating the ADV to follow the trajectory to navigate the unforeseen scenario.
